(19) United States
(12) Patent Application Publication
(10) Pub. No.: US 2009/0158083 A1
(43) Pub. Date: Jun. 18, 2009

(54) CLUSTER SYSTEM AND METHOD FOR OPERATING THE SAME

(75) Inventors: Jin-Hwan Jeong, Seoul (KR); Ok-Gee Min, DaeJeon (KR); Chang-Soo Kim, DaeJeon (KR); Yoo-Hyun Park, DaeJeon (KR); Choon-Seo Park, DaeJeon (KR); Song-Woo Sok, DaeJeon (KR); Yong-Ju Lee, DaeJeon (KR); Won-Jae Lee, DaeJeon (KR); Hag-Young Kim, DaeJeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/186,813

(22) Filed: Aug. 6, 2008

(30) Foreign Application Priority Data
Dec. 17, 2007 (KR) 10-2007-132695

(51) Int. Cl. G06F 11/20

(52) U.S. Cl. 714/4; 714/E11.071

(57) ABSTRACT

Provided are a cluster system, which makes general nodes appear as if they provide seamless services without failure when seen from the outside, and a method for operating the cluster system. The cluster system for operating individual nodes in a distributed management manner includes a board server having a task board registered with a task list, an agent server for managing the task board, and a plurality of general server nodes for performing a corresponding task on the basis of the task list, among which a failed general server node is replaced with another normal general server node.

### CROSS-REFERENCE TO RELATED APPLICATIONS

This application claims priority under 35 U.S.C. §119 to Korean Patent Application No. 10-2007-132695, filed on Dec. 17, 2007, the disclosure of which is incorporated herein by reference in its entirety.

### BACKGROUND OF THE INVENTION

1. Field of the Invention

The present disclosure relates to a cluster system, and more particularly, to a cluster system, which makes general nodes appear as if they provide seamless services without failure when seen from the outside, and a method for operating the cluster system.

This work was supported by the IT R&D program of MIC/IITA[Work management number: 2007-S-016-01, Work title: A Development of Cost Effective and Large Scale Global Internet Service Solution]

2. Description of the Related Art

Generally, a cluster system refers to a system that integrally operates a virtual image program by grouping a plurality of similar nodes.

While closed type cluster systems are operated to provide a high performance operation function only for a specific purpose, open type cluster systems are operated to provide remote services through an Internet connection. Also, as web services are diversified and the capacity of their contents increases, the open type cluster systems are widely used as a platform for the web services such as a web portal.

Meanwhile, to ensure the high availability of services, the typical cluster systems use dedicated management servers, called high availability servers, to manage general nodes that provide real services.

For example, a monitoring server among the management servers is a node that checks whether a failure occurs on a general node.

The monitoring server keeps monitoring general nodes. When a failure occurs on a specific general node, the monitoring server notifies other management node of the failed node. In this case, the other management node checks a service that is executed in the failed node, and transfers the service to other idle normal node. In this way, the failed node is replaced with other normal node as if any failure does not occur on the cluster when seen from the outside. This process appears very effective and optimal, but the failure may occur on the management node itself, thereby causing a problem in the operation of the management node.

That is, the failure cannot be detected if there is no other monitoring server to detect the failure of the monitor server. If the monitoring server is operated with the failure undetected, the monitoring server cannot monitor other general nodes normally. As a result, a service failure may occur on a cluster system. For this reason, the management server such as the monitoring server commonly requires the function capable of detecting and recovering its own failure, which is a high availability technology. However, a cluster includes various types of management servers such as a monitoring server, a service management server, an install/remove management server, etc. Therefore, it incurs high maintenance/repair expense to make all the management servers redundant or triplicated against a failure for high availability. Also, it requires complicated management software to operate the management servers systematically.

### SUMMARY

Therefore, an object of the present invention is to provide a cluster system, which makes general nodes appear as if they provide seamless services without failure when seen from the outside, and a method for operating the cluster system.

Another object of the present invention is to provide a basic operation method based on a task board for embodying a node management function into the cluster system and a distributed management method therefrom.

Further another object of the present invention is to provide a cluster system and a method for operating the same, which may contribute to the saving of the maintenance cost in simplifying the cluster system and ensuring the high availability of the cluster system.

To achieve these and other advantages and in accordance with the purpose(s) of the present invention as embodied and broadly described herein, a cluster system in accordance with an aspect of the present invention includes: a board server having a task board registered with a task list; an agent server for managing the task board; and a plurality of general server nodes for performing a corresponding task on the basis of the task list, among which a failed general server node is replaced with another normal general server node.

To achieve these and other advantages and in accordance with the purpose(s) of the present invention, a method for operating a cluster system including an agent server for managing a task board, a plurality of general server nodes for performing a task in accordance with the task board in accordance with another aspect of the present invention includes: registering, at the agent server, a task list on the task board; performing, at the general server node, the task in accordance with the task list; and updating, at the agent server, the task list to allow other normal general server node to perform the task instead of a failed general server node during the performing of the task in accordance with the task list.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram illustrating a cluster system according to an embodiment of the present invention;

FIG. 2 is a flowchart illustrating a method for operating a general server node according to an embodiment of the present invention; and

FIG. 3 is a flowchart illustrating a method for operating an agent server according to an embodiment of the present invention.

### DETAILED DESCRIPTION OF EMBODIMENTS

A main point of the present invention is to provide a cluster system, which makes general nodes appear as if they provide seamless services without failure when seen from the outside, and a method for operating the cluster system.

For this purpose, the cluster system and the method for operating the same according to the present invention have a technical feature of replacing a failed general server node with a normal general server node by using a basic operation method based on a task board for embodying a node management function into the cluster system and a distributed management method therefrom.

Hereinafter, specific embodiments will be described in detail with reference to the accompanying drawings, and focused on the matters necessary to understand operations and processes according to the present invention.

Specific details of a cluster system and a method for operating the same according to the present invention will be described to fully understand the present invention, but it is understood that the present invention can be implemented by those skilled in the art without these specific details or with various modifications thereof.

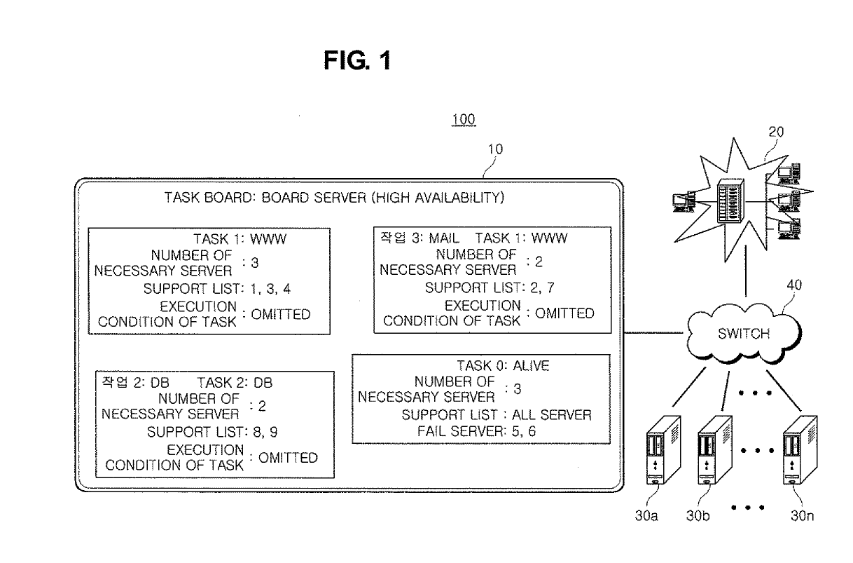

FIG. 1 is a diagram illustrating a cluster system according to an embodiment of the present invention.

Referring to FIG. 1, a cluster system 100 according to the embodiment of the present invention includes a board server 10, an agent server 20, and a plurality of general server nodes 30a to 30n.

The board server 10 registers a task list on a task board. Also, the board server 10 provides the task list to the general server nodes 30a to 30n in accordance with a switching state of a switch 40. In this case, the task board is a common resource shared by all nodes 20 and 30a to 30n of the cluster system 100, which is accessible via a specified interface. Also, services that are necessary to the cluster or provided by the cluster are stored as a form of a task list on the task board. The general server nodes 30a to 30n search the task list on the task board to determine whether an execution condition of the task is satisfied. When the execution condition of the task is satisfied, the general server nodes 30a to 30n support the task. The task board includes a node management list, on which all nodes 20 and 30a to 30n are registered. The node management list includes all general server nodes 30a to 30n except failed general server nodes. Preferably, the failed general server nodes may be registered on a fail list so that they may be separately maintained.

The agent server 20 manages the task board. More specifically, the agent server 20 notices the task list on the task board, shuts down the failed general server nodes, and at the same time removes them from the node management list. In this case, the agent server 20 notices task information on the task list and deletes the task information from the task list. The task information includes the number of general server nodes 30a to 30n required for the task, the execution condition of the task, and a support list of the general server nodes 30a to 30n meeting the execution condition of the task. Also, when a failure occurs on the general server nodes 30a to 30n performing a specific task, the agent server 20 updates the task list so that the failed general server nodes may be replaced with other normal general sever nodes 30a to 30n.

A plurality of the general server nodes 30a to 30n perform a corresponding task on the basis of the task list. Also, the other normal general server nodes 30a to 30n perform the specific task instead of the failed general server nodes.

Referring again to FIG. 1, an operation of the cluster system according to the embodiment of the present invention will be described hereinafter.

First, the cluster system 100 according to the embodiment of the present invention includes a board server 10 having a logic task board to which all server nodes 20 and 30a to 30n are accessible. The agent server 20 registers the task list on the task board and deletes the task list from the task board.

The general server nodes 30a to 30n search the task list on the task board continuously. Then, the agent server 20 notices the task list on the task board, deletes the task list from the board, and continuously checks whether the failure occurs on the general server nodes 30a to 30n.

While being in idle state, the general server nodes 30a to 30n keep searching the task list on the task board. When the task list matching with the specification of the general server nodes 30a to 30n is noticed on the task board, the general server nodes 30a to 30n voluntarily participate in an assignment of a service. When the assignment of the corresponding service is finished, the service is released from the task list. Then, the general server nodes 30a to 30n go into idle state, and search the task list again.

If a failure occurs on general server nodes 30a to 30n, the agent server 20 removes the failed general nodes from the task list, and other normal general server nodes 30a to 30n in idle state voluntarily participate in the task list.

In a related art cluster system, a management server directly searches, examines, and processes the task list when a failure occurs on the general server nodes 30a to 30n or when the general server nodes 30a to 30n are assigned with services. On the other hand, in the cluster system according to the embodiment of the present invention as illustrated in FIG. 1, all general server nodes 30a to 30n voluntarily operate to minimize the role of a management node and perform the same function as that of the related art cluster system.

Only the board server 10 for managing the task board is maintained in high availability in cluster system according to the embodiment of the present invention. Even the agent server 20 corresponds to merely a server group that performs a specific task that is task 0. Accordingly, although the agent server 20 does not have high availability, there is no problem to operate the cluster system.

That is, when a failure occurs on the agent server 20 itself, the agent server 20 may be replaced with other normal server so that the failure on the general server nodes 30a to 30n may be detected.

For example, as illustrated in FIG. 1, three idle nodes are selected from the general server nodes 30a to 30n and assigned for a WWW server. When a failure occurs on one of the general server nodes 30a to 30n, the failed general server node is replaced with other normal general server node. This operation will be described below.

First, an agent server 20 notices a task 1: WWW on a task board. In this case, a necessary server and the execution condition of the task are together noticed on the task board. Next, general server nodes 30a to 30n are supported on a first-come first-served basis to search the task board. Given that the general server nodes 30₁, 30₃, and 30₄ are sequentially supported, the general server nodes 30₁, 30₃, and 30₄ will provide WWW service. The other general server nodes 30a to 30n continue searching other tasks because three nodes necessary for the WWW service have already been volunteered.

If a failure occurs on the general server node 30₃ during the operation of WWW task, the agent server 20 may detect the failure on the general server node 30₃ because the agent server 20 monitors whether a failure occurs on the general server nodes 30a to 30n on the node management list.

In this case, the agent server 20 deletes the failed general server node 30₃ from the node management list, and simultaneously removes the number 3 from a support list for a task 1.

As the failed general server node 30₃ is excluded from the task 1, only two general server nodes 30₁ and 30₄ remain. Since the task 1 requires three general server nodes still, one of the other normal general server nodes 30a to 30n will be supported on a first-come first served basis.

Accordingly, three of general server nodes necessary for the task 1: WWW service will be satisfied.

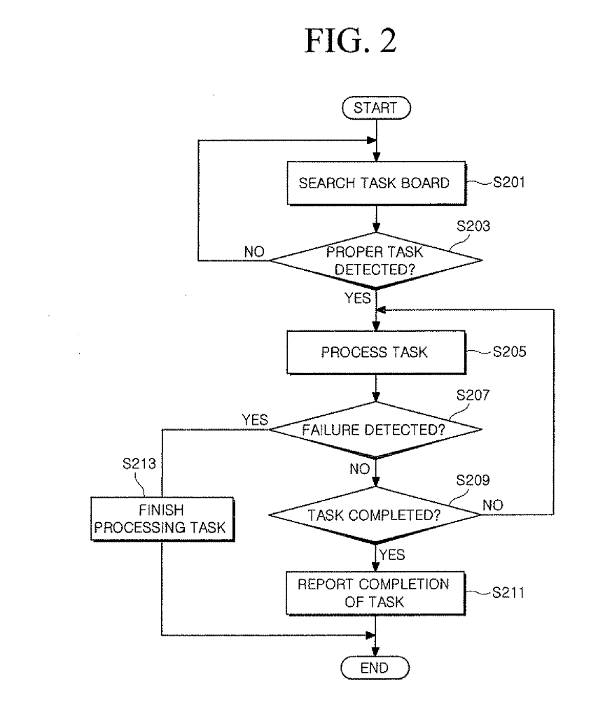

FIG. 2 is a flowchart illustrating a method for operating a general server node according to an embodiment of the present invention.

Referring to FIG. 2, general server nodes 30a to 30n search a task board on a board server 10 in operation S201.

In operation S203, the general server nodes determine whether an adequate task is detected on the task board. If detected, the general server nodes process the corresponding task in operation S205. In operation S207, it is determined whether a failure is detected on the general server nodes 30a to 30n. If not detected, it is determined whether a task is completed in operation S209

If the task is completed, the general server nodes 30a to 30n record on the task board that the task is completed, and report the completion of the task to the board server 10 in operation S211.

Meanwhile, if a failure is detected in operation S209, the general server nodes 30a to 30n finish the current task in operation S213.

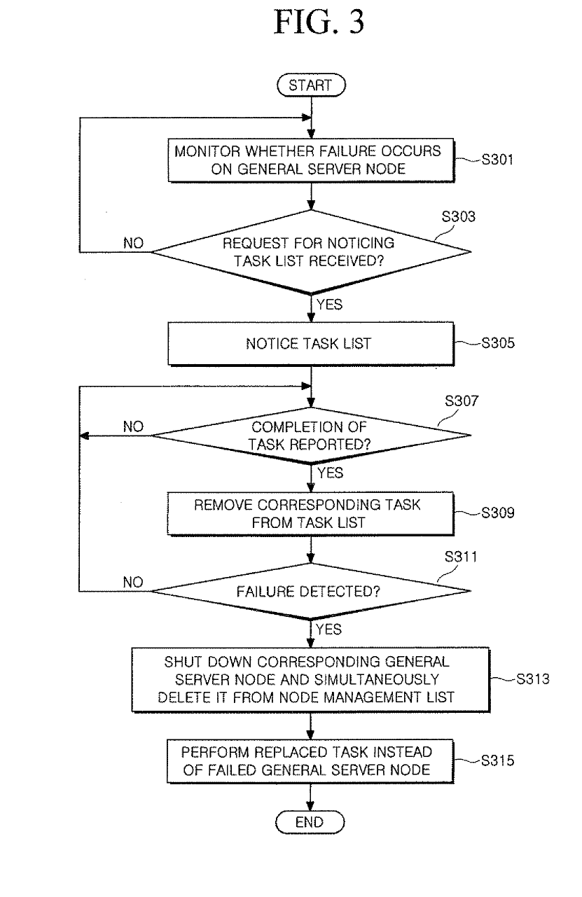

FIG. 3 is a flowchart illustrating a method for operating an agent server according to an embodiment of the present invention.

Referring to FIG. 3, the agent server 20 monitors whether a failure occurs on the general server nodes 30a to 30n in operation S301.

In operation S303, the agent server 20 determines whether there is a request to notice the task list.

If there is a request to notice the task list, the agent server 20 notices the task list in operation S305.

If there is no request to notice the task list, the agent server 20 returns to the operation S301, and monitors whether a failure occurs on the general server node 30a to 30n.

In operation S307, it is determined whether the completion of the task is reported. If the completion of the task is reported, the completed task is removed from the task list in operation S309. In this case, the general server nodes 30a to 30n report the completion of the task to the board server 10. Then, the board server 10 records that the corresponding task in the task list is completed.

However, if the completion of the task is not reported, it is determined whether a failure is detected in operation S311. If the failure is detected, a corresponding general server node is shut down and simultaneously deleted from the node management list in operation S313.

Then, the agent server 20 replaces the corresponding general server node with one of the general server nodes 30a to 30n registered in the node management list in operation S315.

A cluster system according to the present invention has the effect of reducing a management node into a task board, etc. with the high availability of the cluster system retained, and easily managing the cluster system without a participation of the management node because the general server nodes cooperate with each other voluntarily.

Thus, the maintenance cost which accounts for a large portion of the total budget can be reduced with the high availability retained.

Also, the cluster system is basically based on a task board, and at the same time monitors whether a failure occurs on the general server nodes. When the failure occurs on the general server nodes, the failed general nodes are replaced with other normal server nodes, thereby reducing an occurrence of the failure on the management node.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A cluster system for operating individual nodes by using a distributed management scheme, the cluster system comprising:
a board server comprising a task board registered with a task list;
an agent server for managing the task board; and
a plurality of general server nodes for performing a corresponding task on the basis of the task list, among which a failed general server node is replaced with another normal general server node.

2. The cluster system of claim 1, wherein the agent server notices the task list, deletes a completed task from the task list, and checks whether a failure occurs on registered general server nodes.

3. The cluster system of claim 1, wherein the agent server removes a failed general server node from the task list, and manages an idle general server node to participate in an assignment of the task voluntarily.

4. The cluster system of claim 1, wherein the general server node searches the task list at an idle state, and voluntarily participates in an assignment of the task to be assigned with a service.

5. The cluster system of claim 1, wherein the general server node enters the idle state to search a task list for the task suitable for a specification of the general server node on the task board.

6. The cluster system of claim 1, wherein, after performing the corresponding task in the task list, the general server node records in the task list that the corresponding task is completed.

7. The cluster system of claim 1, wherein upon occurrence of a failure, the agent server removes a corresponding general server node from a node management list, and shuts down the corresponding general server node to cut off a power supply.

8. The cluster system of claim 1, wherein the agent server updates the work list to allow other normal general server node to perform a specific task instead of the failed general server node.

9. A method for operating a cluster system having an agent server for managing a task board, a plurality of general server nodes for performing a task in accordance with the task board, the method comprising:
registering, at the agent server, a task list on the task board;
performing, at the general server node, the task in accordance with the task list; and
updating, at the agent server, the task list to allow other normal general server node to perform the task instead of a failed general server node during the performing of the task in accordance with the task list.

10. The method of claim 9, wherein the performing of the task in accordance with the task list comprises:
searching the task list on the task board to determine whether a task suitable for an execution condition of the task is detected; and
processing a corresponding task in the task list when the suitable task is detected.

11. The method of claim 9, further comprising causing the other normal general server node to perform the task in accordance with the updated task list.

12. The method of claim 9, further comprising:
recording, at the general server node, the completion of the task in the task list; and
removing, at the agent server, the task to update the task list.

13. The method of claim 9, wherein the general server node enters an idle state after completion the task, and searches the task list in the idle state.

14. The method of claim 9, further comprising monitoring, at the agent server, whether a failure occurs on the general server nodes.

15. The method of claim 9, further comprising removing the failed general server node from a node management list.
